(19) United States
(12) Patent Application Publication
(10) Pub. No.: US 2025/0365557 A1
(43) Pub. Date: Nov. 27, 2025

(54) POSITIONING METHOD AND COMMUNICATIONS DEVICE

(71) Applicant: QUECTEL WIRELESS SOLUTIONS CO., LTD., Shanghai (CN)

(72) Inventors: Zheng ZHAO, Shanghai (CN); Ling LYU, Shanghai (CN)

(21) Appl. No.: 19/292,653

(22) Filed: Aug. 6, 2025

Related U.S. Application Data
(63) Continuation of application No. PCT/CN2023/139303, filed on Dec. 15, 2023.

(51) Int. Cl. H04W 4/02; H04L 27/26

(52) U.S. Cl. CPC H04W 4/025; H04L 27/261

(57) ABSTRACT

A positioning method and a communications device are provided. One example method includes: receiving first information by a first device, wherein the first information indicates a first parameter of a second device, and the first parameter is related to positioning of the first device; and processing, by the first device, a first phase difference for a plurality of second devices based on the first parameter, to obtain a target phase difference, wherein the target phase difference is used for positioning the first device.

### CROSS-REFERENCE TO RELATED APPLICATIONS

This application is a continuation of International Application No. PCT/CN2023/139303, filed on Dec. 15, 2023, the disclosure of which is hereby incorporated by reference in its entirety.

### TECHNICAL FIELD

This application relates to the technical field of communications, and more specifically, to a positioning method and a communications device.

### BACKGROUND

Currently, carrier phase differential positioning is commonly used. In this positioning approach, a phase difference between signal phases measured by a receiving device is calculated and then positioning is performed according to the phase difference. Differential processing can eliminate most errors during transmission of a signal and improve positioning accuracy.

However, users intend to perform positioning in increasingly complex scenarios and make increasingly high demands for reported parameters, which are not satisfied by the commonly used positioning approach.

### SUMMARY

This application provides a positioning method and a communications device. The following describes several aspects involved in the embodiments of this application.

According to a first aspect, a positioning method is provided, including: receiving first information by a receiving device, where the first information indicates a first parameter of a transmitting device, and the first parameter is related to positioning of the receiving device; and processing, by the receiving device, a first phase difference for multiple transmitting devices based on the first parameter, to obtain a target phase difference, where the target phase difference is for positioning the receiving device.

According to a second aspect, a positioning method is provided, including: receiving first information by a positioning device, where the first information indicates a first parameter of a transmitting device, and the first parameter is related to positioning of the receiving device; receiving, by the positioning device, second information sent by a receiving device, where the second information includes a first phase difference for multiple transmitting devices; and processing, by the positioning device, the first phase difference for the multiple transmitting devices based on the first parameter, to obtain a target phase difference, where the target phase difference is for positioning the receiving device.

According to a third aspect, a positioning method is provided, including: transmitting, by a transmitting device, first information to a positioning device, where the first information indicates a first parameter of the transmitting device, and the first parameter is related to positioning of the receiving device. The first parameter is used by the positioning device to process a first phase difference for multiple transmitting devices to obtain a target phase difference, and the target phase difference is for positioning the receiving device.

According to a fourth aspect, a positioning method is provided, including: measuring, by a receiving device, a first reference signal sent by a first transmitting device to obtain a first phase; measuring, by the receiving device, a second reference signal sent by a second transmitting device to obtain a second phase, where a second parameter of the first reference signal is different from a second parameter of the second reference signal, and the second parameter includes a wavelength and/or a frequency; and determining, by the receiving device, a target phase difference based on the second parameter of the first reference signal, the second parameter of the second reference signal, the first phase, and the second phase, where the target phase difference is for positioning the receiving device.

According to a fifth aspect, a positioning method is provided, including: measuring, by a receiving device, a first reference signal sent by a first transmitting device to obtain a first phase; measuring, by the receiving device, a second reference signal sent by a second transmitting device to obtain a second phase, wherein a second parameter of the first reference signal is different from a second parameter of the second reference signal, and the second parameter includes a wavelength and/or a frequency; and transmitting, by the receiving device, fourth information to a positioning device, where the fourth information indicates the first phase and the second phase, the second parameter of the first reference signal, and the second parameter of the second reference signal, and the fourth information is for positioning the receiving device.

According to a sixth aspect, a positioning method is provided, including: receiving, by a positioning device, fifth information sent by a receiving device, where the fifth information indicates a first phase and a second phase, the first phase is obtained by measuring a first reference signal sent by a first transmitting device, the second phase is obtained by measuring a second reference signal sent by a second transmitting device, a second parameter of the first reference signal is different from a second parameter of the second reference signal, and the second parameter includes a wavelength and/or a frequency; and receiving, by the positioning device, sixth information, where the sixth information indicates the second parameter of the first reference signal and the second parameter of the second reference signal; and determining, by the positioning device, a target phase difference based on the first phase, the second phase, the second parameter of the first reference signal, and the second parameter of the second reference signal, where the target phase difference is for positioning the receiving device.

According to a seventh aspect, a communications device is provided, where the communications device is a receiving device and includes: a receiving unit, configured to receive first information, where the first information indicates a first parameter of a transmitting device, and the first parameter is related to positioning of the receiving device; and a processing unit, configured to process a first phase difference for multiple transmitting devices based on the first parameter, to obtain a target phase difference, where the target phase difference for positioning the receiving device.

According to an eighth aspect, a communications device is provided, where the communications device is a positioning device, and the communications device includes: a receiving unit, configured to receive first information, where the first information indicates a first parameter of a transmitting device, and the first parameter is related to positioning of the receiving device, where the receiving unit is further configured to receive second information sent by a device, where the second information includes a first phase difference for multiple transmitting devices; and a processing unit, configured to process the first phase difference for the multiple transmitting devices based on the first parameter, to obtain a target phase difference, where the target phase difference is for positioning the receiving device.

According to a ninth aspect, a communications device is provided, where the communications device is a transmitting device and includes: a transmitting unit, configured to send first information to a positioning device, where the first information indicates a first parameter of the transmitting device, and the first parameter is related to positioning of a receiving device. The first parameter is used by the positioning device to process the first phase difference for multiple transmitting devices to obtain a target phase difference, and the target phase difference is for positioning the receiving device.

According to a tenth aspect, a communications device is provided, where the communications device is a receiving device and includes: a measurement unit, configured to measure a first reference signal sent by a first transmitting device to obtain a first phase, and measure a second reference signal sent by a second transmitting device to obtain a second phase, where a second parameter of the first reference signal is different from a second reference signal, and the second parameter includes a wavelength and/or a frequency; and a determining unit, configured to determine a target phase difference based on the second parameter of the first reference signal, the second parameter of the second reference signal, the first phase, and the second phase, where the target phase difference is for positioning the receiving device.

According to an eleventh aspect, a communications device is provided, where the communications device is a receiving device and includes: a measurement unit, configured to measure a first reference signal sent by a first transmitting device to obtain a first phase, and measure a second reference signal sent by a second transmitting device to obtain a second phase, where a second parameter of the first reference signal is different from a second reference signal, and the second parameter includes a wavelength and/or a frequency; and a transmitting unit, configured to send fourth information to a positioning device, where the fourth information indicates the first phase, the second phase, the second parameter of the first reference signal, and the second parameter of the second reference signal, and the fourth information is for positioning the receiving device.

According to a twelfth aspect, a communications device is provided, where the communications device is a positioning device and includes: a receiving unit, configured to receive fifth information sent by a receiving device, where the fifth information indicates a first phase and a second phase, the first phase is obtained by measuring a first reference signal sent by a first transmitting device, the second phase is obtained by measuring a second reference signal sent by a second transmitting device, a second parameter of the first reference signal is different from a second parameter of the second reference signal, and the second parameter includes a wavelength and/or a frequency, where the receiving unit is further configured to receive sixth information, where the sixth information indicates the second parameter of the first reference signal and the second parameter of the second reference signal; and a determining unit, configured to determine a target phase difference based on the first phase, the second phase, the second parameter of the first reference signal, and the second parameter of the second reference signal, where the target phase difference is for positioning the receiving device.

According to a thirteenth aspect, a communications device is provided, including a memory and a processor, where the memory is configured to store a program, and the processor is configured to invoke the program in the memory to perform the method according to any one of the first aspect to the sixth aspect.

According to a fourteenth aspect, an apparatus is provided, including a processor, configured to invoke a program from a memory to perform the method according to any one of the first aspect to the sixth aspect.

According to a fifteenth aspect, a chip is provided, including a processor, configured to invoke a program from a memory, so that a device installed with the chip performs the method according to any one of the first aspect to the sixth aspect.

According to a sixteenth aspect, a computer readable storage medium is provided, where a program is stored thereon, and the program causes a computer to perform the method according to any one of the first aspect to the sixth aspect.

According to a seventeenth aspect, a computer program product is provided, including a program, where the program causes a computer to perform the method according to any one of the first aspect to the sixth aspect.

According to an eighteenth aspect, a computer program is provided, where the computer program causes the computer to perform the method according to any one of the first aspect to the sixth aspect.

In the embodiments of this application, a first phase difference may be processed based on a first parameter (for example, an initial phase, a hardware delay, and a clock error) to obtain a target phase difference, and the receiving device is positioned based on the target phase difference. Taking the first parameter into consideration during determination of the target phase difference can minimize impact of the first parameter on the positioning result and improve the positioning accuracy.

### BRIEF DESCRIPTION OF THE DRAWINGS

FIG. 1 shows a wireless communications system 100 applied to an embodiment of this application.

FIG. 2 is a schematic diagram showing a phase differential positioning approach applied in an embodiment of this application.

FIG. 3 is a schematic diagram showing a receiving phase for a reference signal.

FIG. 4 is a schematic flowchart showing a positioning method for reference signals having the same frequency according to an embodiment of this application.

FIG. 5 is a schematic flowchart showing the positioning method for reference signals having the same frequency according to another embodiment of this application.

FIG. 6 is a schematic flowchart showing the positioning method for reference signals having the same frequency according to another embodiment of this application.

FIG. 7 is a schematic flowchart showing a positioning method for reference signals at different frequencies according to an embodiment of this application.

FIG. 8 is a schematic flowchart showing the positioning method for reference signals at different frequencies according to another embodiment of this application.

FIG. 9 is a schematic flowchart showing the positioning method for reference signals at different frequencies according to another embodiment of this application.

FIG. 10 is a schematic block diagram showing a communications device according to an embodiment of this application.

FIG. 11 is a schematic block diagram showing the communications device according to another embodiment of this application.

FIG. 12 is a schematic block diagram showing the communications device according to another embodiment of this application.

FIG. 13 is a schematic block diagram showing the communications device according to another embodiment of this application.

FIG. 14 is a schematic block diagram showing the communications device according to another embodiment of this application.

FIG. 15 is a schematic block diagram showing the communications device according to another embodiment of this application.

FIG. 16 is a schematic structural diagram showing an apparatus according to an embodiment of this application.

### DETAILED DESCRIPTION OF THE EMBODIMENTS

The following describes the technical solutions in this application with reference to the drawings.

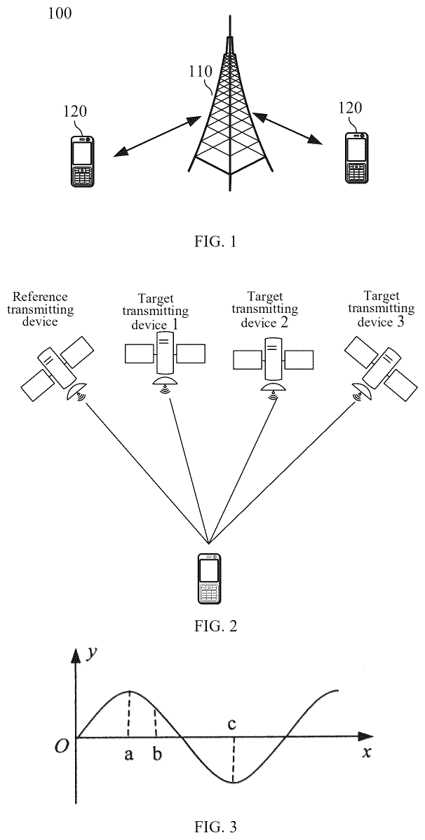

FIG. 1 illustrates a wireless communications system 100 applied to the embodiments of this application. The wireless communications system 100 includes a network device 110 and a terminal device 120. The network device 110 may be a device that communicates with the terminal device 120. The network device 110 can provide communication coverage for a specific geographical area, and can communicate with the terminal device 120 located inside the coverage area.

FIG. 1 exemplarily shows one network device and two terminals. Optionally, the wireless communications system 100 may include multiple network devices, and a coverage range of each network device may include another quantity of terminal devices. This is not limited in the embodiments of this application.

Optionally, the wireless communications system 100 may further include another network entity such as a network controller and a mobility management entity. This is not limited in the embodiments of this application.

It should be understood that the technical solutions in the embodiments of this application may be applied to various communications systems, for example, a 5th generation (5G) system or a new radio (NR), a long-term evolution (LTE) system, an LTE frequency division duplex (FDD) system, and an LTE time division duplex (TDD). The technical solutions provided in this application may further be applied to future communications systems, such as a 6th-generation mobile communications system or a satellite communications system.

The terminal device in the embodiments of this application may also be referred to as user equipment (UE), an access terminal, a user unit, a user station, a mobile station, a mobile station (MS), a mobile terminal (MT), a remote station, a remote terminal, a mobile device, a user terminal, a terminal, a wireless communications device, a user agent, or a user apparatus. The terminal device in the embodiments of this application may be a device that provides voice and/or data connectivity to a user, and may be configured to connect a person, a thing, and a machine, for example, a handheld device and an in-vehicle device that have a wireless connection function. The terminal device in the embodiments of this application may be a mobile phone, a Pad, a notebook computer, a laptop computer, a mobile internet device (MID), a wearable device, a virtual reality (VR) device, an augmented reality (AR) device, a wireless terminal in industrial control, a wireless terminal for self-driving, a wireless terminal in a remote medical surgery, a wireless terminal in a smart grid, a wireless terminal in a transportation safety, a wireless terminal in a smart city, a wireless terminal in a smart home, or the like. Optionally, the UE may be configured to serve as a base station. For example, the UE may act as a scheduling entity that provides a sidelink signal between UEs in V2X, D2D, etc. For example, cellular phones and vehicles communicate with each other through side link signals. Cellular phones communicate with smart home devices without having to relay communication signals via base stations.

The network device in the embodiments of this application may be a device for communicating with a terminal device, and the network device may also be referred to as an access network device or a radio access network device. For example, the network device may be a base station. The network device in the embodiments of this application may be a radio access network (RAN) node (or device) that accesses a radio network via a terminal device. The base station may broadly cover various names in or replace with the following names: a NodeB, an evolved NodeB (eNB), a next-generation base station (next generation NodeB, gNB), a relay station, an access point, a transmission point (transmitting and receiving point, TRP), a transmitting point (TP), a master station MeNB, a secondary station SeNB, a multimode radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof. The base station may further refer to a communications module, a modem, or a chip that is configured to be disposed in the foregoing device or apparatus. The base station may further be a mobile switching center and a device-to-device (D2D), a vehicle-to-everything (V2X), a device that functions as a base station in machine-to-machine (M2M) communication, a network side device in a 6G network, a device that functions as a base station in a future communications system, or the like. The base station may support a network of a same or different access technologies. A specific technology and a specific device form used by the network device are not limited in the embodiments of this application.

The base station may be stationary or mobile. For example, a helicopter or drone may be configured to act as a mobile base station, and one or more cells can move according to the location of the mobile base station. In other examples, a helicopter or drone may be configured as a device for communicating with another base station.

In some deployments, the network device in the embodiments of this application may refer to the CU or DU, or the network device includes a CU and a DU. The gNB may further include an AAU.

The network device and the terminal device may be deployed on land indoors or outdoors, and the network device and the terminal device each may be a handheld or in-vehicle device. The network device and the terminal device may also be deployed on a water surface, on airborne aircraft, balloons and satellites. A scenario in which the network device and the terminal device are located is not limited in the embodiments of this application.

It should be understood that all or a part of functions of the communications device in this application may be implemented by software running on hardware or by a virtualized function instantiated on a platform (e.g., a cloud platform).

Currently, a carrier phase difference (CPD) or a real time kinematic (RTK) is commonly used for positioning. In this positioning approach, a phase difference between signal phases measured by receiving devices is calculated and then positioning is performed according to the phase difference. Differential processing in this approach can eliminate most errors during transmission of a signal and improve positioning accuracy. The following describes the positioning method involved in the embodiments of this application with reference to FIG. 2.

Referring to FIG. 2, the positioning system includes a receiving device, a reference transmitting device, and at least one target transmitting device. The receiving device may be a terminal device, or may be a CPE. The transmitting device may also be a transmission point. The transmitting device may be, for example, a satellite. In some embodiments, the transmitting device is a base station. For example, the base station may include a serving cell base station and/or a neighboring cell base station.

The receiving device receives a reference signal sent by the reference transmitting device, and measures the reference signal to obtain a first phase (or referred to as first observation data). The receiving device further receives a reference signal sent by the target transmitting device 1, and measures the reference signal to obtain a second phase (or referred to as second observation data). The receiving device performs differential processing on the first phase and the second phase to obtain a phase difference (or referred to as differential data). In some embodiments, the receiving device measures the reference signal at multiple moments to obtain a first phase and a second phase at different moments, and perform differential processing on the first phase and the second phase to obtain multiple phase differences.

In some embodiments, the receiving device further receives a reference signal sent by the target transmitting device 2, and measures the reference signal to obtain a third phase. The receiving device performs differential processing on the third phase and the first phase to obtain a phase difference. For other target transmitting device (for example, the target transmitting device 3), the calculation is similar. The three-dimensional coordinates of the receiving device and the precision of the receiving device are calculated according to these phase differences.

The reference signal in this embodiment of this application is, for example, a positioning reference signal (PRS).

Referring to FIG. 3, if wireless signals (for example, reference signals) travels over different distances, the receiving device also receives the wireless signals of different phases. In FIG. 3, the x axis represents a transmission distance, and the y axis represents a phase of a received wireless signal. a, b, and c indicate different transmission distances.

From an initial wireless communications system to a current fifth generation mobile communications system, the operating frequency increases. As the operating frequency increases, an anti-interference capability of a communications signal decreases, and complexity of delay detection increases, which increases complexity of positioning processing. When the carrier frequency of the signal is increased, the wavelength of the signal will be shortened. For example, when the operating frequency of the signal is 40 GHz, the wavelength of the signal is about 6 mm. When the transmission distance of the signal is more than 1 millimeter, the phase of the signal is close to a difference of 90 degrees. Therefore, the phase information reflects a distance between the receiving device and the transmitting device more precisely, and carrier phase positioning obtains a positioning result with relatively high precision.

Generally, in a transmission process of a communications signal, various errors such as a satellite error, an atmospheric error, a multi-path error, and a device error are carried, resulting in an inaccurate data solution, thereby causing inaccurate positioning. For a transmit device and a receive device that are not far away from each other, the receive device calculates a difference between phases measured by different transmit devices, eliminating errors such as an atmospheric error and also eliminating errors caused by the receive device.

In some embodiments, the receiving device is a terminal device, or is also a positioning reporting unit (PRU). The positioning device in this embodiment of this application is a unit that has a positioning and resolving function. The positioning device is a positioning server, a location management function (LMF), a serving cell, a positioning reference unit, or a terminal device.

In transmission of a wireless signal, a phase measured by the receiving device is related to other factors in addition to a distance between the receiving device and the transmitting device. For example, the measured phase is further related to factors such as a clock error, a hardware delay, and a multipath of the receiving device. For another example, the measured phase is further related to factors such as a clock error and a hardware delay of the transmitting device.

The original phase observation equation is as follows:

$${ϕ}_{r , i}^{′ s} = [ {ρ}_{r}^{s} + c ( {dt}_{r} - {dt}^{s} ) - {I}_{r , i}^{s} + {T}_{r}^{s} + {ε}_{r , i}^{′ s} ] + ( {φ}_{r , i} + {δ}_{r , i} - {φ}_{i}^{s} - {δ}_{i}^{s} + {N}_{r , j}^{s} ) / {λ}_{i}$$

where r is the receiving device; s is the transmitting device or a serial number of the transmitting device; i is the frequency;

$${ϕ}_{r , i}^{′ s}$$

is the phase (or phase observation), in meters; λᵢ is the wavelength of the carrier phase, in meters;

$${ρ}_{r}^{s}$$

is the geometric distance between the transmitting device and the receiving device, in meters; c is the speed of light, in m/s; dtᵣ is the clock error of the receiving device, in seconds; dt^{s} is the clock error of the transmitting device, in seconds;

$${I}_{r , i}^{s}$$

is the ionospheric delay, in meters;

$${T}_{r}^{s}$$

is the tropospheric delay in meters; φ′_{r,i} represents the initial phase of the receiving device in cycles; δ′_{r,i} represents the hardware delay of the receiving device in cycles;

$${φ}_{i}^{′ s}$$

represents the initial phase of the transmitting device in cycles;

$${δ}_{i}^{′ s}$$

represents the hardware delay of the transmitting device in cycles;

$${ε}_{r , i}^{′ s}$$

represents other errors such as multipath and noise of the phase observation, in meters; and

$${N}_{r , j}^{′ s}$$

represents the phase error caused by other interference in cycles.

In some embodiments, the foregoing hardware delay may also be referred to as a phase hardware delay.

The above expression is converted into an expression of phase (in cycles), and the calculation expression of phase is as follows:

$${ϕ}_{r , i}^{s} = [ {ρ}_{r}^{s} + c ( {dt}_{r} - {dt}^{s} ) - {I}_{r , i}^{s} + {T}_{r}^{s} + {ε}_{r , i}^{′ s} ] / {λ}_{i} + ( {φ}_{r , i} + {δ}_{r , i} - {φ}_{i}^{s} - {δ}_{i}^{s} )$$

where r is the receiving device; s is the transmitting device or a serial number of the transmitting device; i is the frequency;

$${ϕ}_{r , i}^{s}$$

is the phase (or phase observation), in cycles; λᵢ is the wavelength of the carrier phase, in meters;

$${ρ}_{r}^{s}$$

is the geometric distance between the transmitting device and the receiving device, in meters; c is the speed of light, in m/s; dtᵣ is the clock error of the receiving device, in seconds; dt^{s} is the clock error of the transmitting device, in seconds;

$${I}_{r , i}^{s}$$

is the ionospheric delay, in meters;

$${T}_{r}^{s}$$

is the tropospheric delay in meters; φ_{r,i} represents the initial phase of the receiving device in cycles; δ_{r,i} represents the hardware delay of the receiving device in cycles;

$${φ}_{i}^{s}$$

represents the initial phase of the transmitting device in cycles;

$${δ}_{i}^{s}$$

represents the hardware delay of the transmitting device in cycles;

$${ε}_{r , i}^{s}$$

represents other errors such as multipath and noise of the phase observation, in meters.

The receiving device receives signals from different transmitting devices and obtains signal phase information for different transmitting devices. Assuming that the receiving device estimates the phase of the reference signals from a transmitting device s1 and a transmitting device s2 respectively, the phase calculation expression is as follows:

$${ϕ}_{r , i}^{s 1} = [ {ρ}_{r}^{s 1} + c ( {dt}_{r} - {dt}^{s 1} ) - {I}_{r , i}^{s 1} + {T}_{r}^{s 1} + {ε}_{r , i}^{′ s 1} ] / {λ}_{i} + ( {φ}_{r , i} + {δ}_{r , i} - {φ}_{i}^{s 1} - {δ}_{i}^{s 1} )$$

$${ϕ}_{r , i}^{s 2} = [ {ρ}_{r}^{s 2} + c ( {dt}_{r} - {dt}^{s 2} ) - {I}_{r , i}^{s 2} + {T}_{r}^{s 2} + {ε}_{r , i}^{′ s 2} ] / {λ}_{i} + ( {φ}_{r , i} + {δ}_{r , i} - {φ}_{i}^{s 2} - {δ}_{i}^{s 2} )$$

where r is the receiving device; s is the transmitting device or a serial number of the transmitting device; i is the frequency;

$${ϕ}_{r , i}^{s 1}$$

represents the phase for the transmitting device s1,

$${ϕ}_{r , i}^{s 2}$$

represents the phase for the transmitting device s2, in cycles; λᵢ represents the wavelength of the reference signal, in meters;

$${ρ}_{r}^{s 1}$$

represents the geometric distance between the receiving device and the transmitting device s1,

$${ρ}_{r}^{s 2}$$

represents the geometric distance between the receiving device and the transmitting device s2, in meters; c represents the speed of light, in m/s; dtᵣ represents the clock error of the receiving device, in seconds; dt^{s1} represents the clock error of transmitting device s1, dt^{s2} represents the clock error of transmitting device s2, in seconds

$${I}_{r , i}^{s 1}$$

represents the ionospheric delay of the transmitting device s1, and

$${I}_{r , i}^{s 2}$$

represents the ionospheric delay of the transmitting device s2, both in meters;

$${T}_{r}^{s 1}$$

represents the tropospheric delay of the transmitting device s1, and

$${T}_{r}^{s 2}$$

represents the tropospheric delay of the transmitting device s2, both in meters; φ_{r,i} represents the initial phase of the receiving device, in cycles;

$${φ}_{i}^{s 1}$$

represents the initial phase or the transmitting device s1, and

$${φ}_{i}^{s 2}$$

represents the initial phase of the transmitting device s2, both in cycles; δ_{r,i} represents the phase hardware delay of the receiving device, in cycles;

$${δ}_{i}^{s 1}$$

represents the phase hardware delay of the transmitting device s1, and

$${δ}_{i}^{s 2}$$

represents the phase hardware delay of the transmitting device s2, both in cycles; and

$${ε}_{r , i}^{′ s 1}$$

represents other errors such as multipath and noise of the phase observation, in meters.

Ionospheric delay is caused by ionized gases in the ionosphere, which affects the transmission of signals from the transmitting device to the receiving device. Although ionospheric delay is a common source of error, its impact can be partially eliminated or reduced through differential technology (or differential GNSS technology). Taking satellite communications as an example, differential technology refers to the use of multiple satellite signals to reduce the common errors caused by the ionosphere by calculating the differences between different satellite signals. Differential technology deploys one or more reference stations on the ground, measures the difference between the signals they receive and the actual position, and broadcasts this difference information to users for delay correction. Therefore, the receiving device estimates the phase of the signals from satellites s1 and s2, and calculates the carrier phase difference, ignoring the impact of the ionospheric delay.

Tropospheric delay is caused by water vapor in the atmosphere, which affects the transmission of signals from the transmitting device to the receiving device. Tropospheric delay is reduced by differentiating the reference signals of different receiving devices. Taking satellite communication as an example, when using multiple satellite signals, since the atmospheric conditions change slowly in space, the impact of tropospheric delay is eliminated or reduced by calculating the difference between different satellite signals. This difference process is called Doppler difference. By differentiating multiple satellite signals, the common error caused by the atmosphere is reduced. This is widely used in differential technology (or differential GNSS technology). In differential technology, some base stations measure the difference between the true position and the actual position of the satellite signals they receive, and report this difference information to users, so that users can correct the delay. In general, tropospheric delay is eliminated or reduced by Doppler difference, thereby improving the accuracy and reliability of the positioning system. Therefore, the receiving device estimates the phase of the signals from satellites s1 and s2 and calculates the carrier phase difference, ignoring the impact of the tropospheric delay.

Although the positioning accuracy is improved by differential technology, the current positioning method still cannot meet increasingly high positioning needs. Therefore, how to further improve the positioning accuracy has become an urgent problem to be solved.

As mentioned above, the receiving device measures the reference signals transmitted by different transmitting devices, obtains the phases of the signal, ands calculates a difference between the phases of the signals to obtain the phase difference, which can be used for locating the receiving device. The frequencies of the reference signals sent by different transmitting devices are equal or different. The following discusses these two situations respectively.

It should be noted that the different frequencies of the reference signals also refer to the different wavelengths of the reference signals, or the different operating frequencies of the reference signals. The same frequencies of the reference signals also refer to the same wavelengths of the reference signals, or the same operating frequencies of the reference signals.

### 1. Reference Signals Having the Same Operating Frequency

Assuming that the reference signals from the transmitting devices s1 and s2 have the same operating frequency, that is, the wavelengths of the reference signals sent by the receiving devices s1 and s2 are equal, the calculation expression for the phase difference is as follows.

$${ϕ}_{r , i}^{s 1} - {ϕ}_{r , i}^{s 2} = \frac{[ {ρ}_{r}^{s 1} + c ( d {t}_{r} - d {t}^{s 1} ) - {I}_{r , i}^{s 1} + {T}_{r}^{s 1} + {ε}_{r , i}^{′ s 1} ]}{{λ}_{i}} + ( {φ}_{r , i} + {δ}_{r , i} - {φ}_{i}^{s 1} - {δ}_{i}^{s 1} ) - \frac{[ {ρ}_{r}^{s 2} + c ( d {t}_{r} - d {t}^{s 2} ) - {I}_{r , i}^{s 2} + {T}_{r}^{s 2} + {ε}_{r , i}^{′ s 2} ]}{{λ}_{i}} - ( {φ}_{r , i} + {δ}_{r , i} - {φ}_{i}^{s 2} - {δ}_{i}^{s 2} )$$

If the same receiving device performs the phase estimation, factors such as the initial phase, hardware delay, and clock error of the receiving device are eliminated. The expression after eliminating these factors is as follows.

$${ϕ}_{r , i}^{s 1} - {ϕ}_{r , i}^{s 2} = \frac{[ {ρ}_{r}^{s 1} + c ( - {dt}^{s 1} ) + {ε}_{r , i}^{′ s 1} ]}{{λ}_{i}} + ( - {φ}_{i}^{s 1} - {δ}_{i}^{s 1} ) - \frac{[ {ρ}_{r}^{s 2} + c ( - {dt}^{s 2} ) + {ε}_{r , i}^{′ s 2} ]}{{λ}_{i}} - ( - {φ}_{i}^{s 2} - {δ}_{i}^{s 2} )$$

The clock error is the deviation of the clock of the receiving device or the transmitting device from the time of the GNSS system. This clock error is caused by the fact that the atomic clock or other clock device of the transmitting device or the receiving device is not completely accurate. Although the accuracy of the clock of modern transmitting devices is quite high, there is still a certain clock error. In many applications, the clock error of the transmitting device is usually considered to be a constant because it changes relatively slowly. In the receiving device (e.g., a GNSS receiver), this clock error is taken into account and corrected accordingly. Clock correction is usually done through the navigation message of the transmitting device signal, which contains the clock information of the transmitting device as well as some calibration parameters, so that the receiving device can accurately calculate the position of the transmitting device. Although the clock error of the transmitting device is usually taken into account in the calculation of the receiving device, the clock error may need to be handled more delicately in some high-precision applications especially in scientific research or engineering applications with extremely high accuracy requirements. In these cases, more complex models may need to be used to account for the changes in the clock error of the transmitting device. Overall, in many common applications, the clock error of the transmitting device is regarded as an error source that is corrected and managed. However, in some applications with very high accuracy requirements, the clock error of the transmitting device may need to be handled more carefully.

If the clock error of the transmitting device is ignored, the phase difference can be calculated as follows.

$${ϕ}_{r , i}^{s 1} - {ϕ}_{r , i}^{s 2} = \frac{[ {ρ}_{r}^{s 1} + {ε}_{r , i}^{′ s 1} ]}{{λ}_{i}} + ( - {φ}_{i}^{s 1} - {δ}_{i}^{s 1} ) - \frac{[ {ρ}_{r}^{s 2} + {ε}_{r , i}^{′ s 2} ]}{{λ}_{i}} - ( - {φ}_{i}^{s 2} - {δ}_{i}^{s 2} )$$

Signal transmitting devices (such as antennas, amplifiers, etc.) on wireless communications devices will cause delay. This delay is usually caused by the transmission time and processing time required for wireless signals when passing through the hardware components on the communications device. Taking satellites as an example, in general, satellite hardware delay errors are difficult to completely eliminate because they are related to the specific hardware design and implementation on the satellite. However, in GNSS systems, these errors are usually measured and modeled on the satellite side so that corresponding corrections can be made. This correction is usually achieved by providing relevant information in the navigation message or by using advanced signal processing techniques. On the GNSS receiver side, the hardware delay is estimated and corrected based on the information in the received navigation message. In addition, high-precision GNSS receivers may use multipath modeling and correction to further reduce hardware delay errors. Although satellite hardware delay errors cannot be completely eliminated, effective modeling and correction can reduce their impact in GNSS systems, thereby improving positioning accuracy. Continuous development and improvement of technology will help further reduce this type of errors.

As can be seen from the above, the first parameters (such as the initial phase, the hardware delay and the clock error) of the transmitting device cannot be completely eliminated at present, and will affect the positioning accuracy. The current positioning method is directly based on the first phase difference of multiple transmitting devices for positioning, without considering the impact of the first parameters of the transmitting device on positioning, resulting in inaccurate positioning.

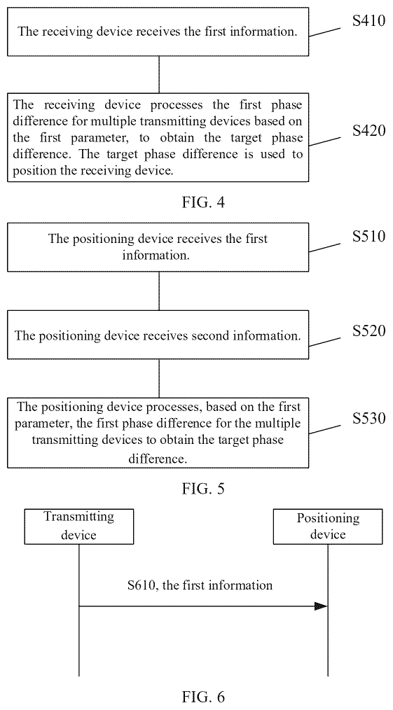

Based on this, an embodiment of this application provides a positioning method. In the method, a first phase difference is processed based on a first parameter to obtain a target phase difference, and the receiving device is positioned based on the target phase difference. Because the first parameter is considered when determining the target phase difference, impact of the first parameter on a positioning result is reduced, so that positioning accuracy can be improved. The following describes the solutions in the embodiments of this application in detail with reference to FIG. 4.

Referring to FIG. 4, in step S410, the receiving device receives the first information.

The first information indicates a first parameter of the transmitting device, where the first parameter is related to positioning of the receiving device, or the first parameter is used to position the receiving device. In some implementations, the first parameter refers to a parameter that affects positioning of the receiving device. For example, the first parameter includes one or more of the following: an initial phase, a hardware delay, or a clock error. In some embodiments, the first parameter includes one or more of the following: a difference of an initial phase, a difference of a hardware delay, and a difference of a clock error. The difference of the initial phase refers to a difference between the initial phase of the first transmitting device and the initial phase of the second transmitting device. The difference of the hardware delay refers to a difference between a hardware delay of the first transmitting device and a hardware delay of the second transmitting device. The difference of clock error refers to a difference between a clock error of the first transmitting device and a clock error of the second transmitting device. Reporting the difference of various parameters can reduce the reported amount of data.

In some implementations, the phase difference reported by the receiving device includes a phase difference caused by different initial phases or hardware delays from different transmitting ends. In this case, the receiving device or the transmitting device transmits a first parameter to the positioning device, so that the positioning device locates the receiving device based on the first parameter. If the first parameter is sent by the receiving device to the positioning device, the transmitting device first transmits the first parameter to the receiving device, and then the receiving device transmits the first parameter to the positioning device.

In some embodiments, the transmitting device refers to a device capable of transmitting a reference signal for positioning. The transmitting device is a transmission point or a base station. The transmitting device includes a reference transmitting device and a target transmitting device. In some implementations, the transmitting device is a satellite. The first parameter is an initial phase, a hardware delay, or a clock error of the satellite.

In some embodiments, the first information includes a first parameter. For example, the first parameter includes one or more of the following: an initial phase, a hardware delay, and a clock error. The first information includes an initial phase, a hardware delay, and a clock error of the transmitting device.

In step S420, the receiving device processes the first phase difference for multiple transmitting devices based on the first parameter, to obtain the target phase difference. The target phase difference is used to position the receiving device.

In some embodiments, the first phase difference is a phase difference for two transmitting devices. It is assumed that the multiple transmitting devices include a first transmitting device and a second transmitting device, a first phase difference is a difference between a first phase and a second phase. The first phase is a phase for the first transmitting device, and the second phase is a phase for the second transmitting device. It should be noted that the phase for the first transmitting device is obtained by measuring a reference signal sent by the first transmitting device. The phase for the second transmitting device is obtained by measuring a reference signal sent by the second transmitting device.

In some implementations, the first transmitting device transmits the first reference signal to the receiving device, and the receiving device measures the first reference signal to obtain the first phase. The first phase is, for example, a signal phase when the receiving device receives the first reference signal. The second transmitting device transmits a second reference signal to the receiving device, and the receiving device measures the second reference signal to obtain a second phase. The second phase is, for example, a signal phase when the receiving device receives the second reference signal. In some implementations, the receiving device calculates a difference between the first phase and the second phase to obtain the first phase difference.

In some embodiments, one of the first transmitting device and the second transmitting device is the reference transmitting device, and the other is the target transmitting device.

In some embodiments, a frequency of the first reference signal is equal to a frequency of the second reference signal, or a wavelength of the first reference signal is equal to a wavelength of the second reference signal. In some implementations, the frequency of the reference signal is also referred to as the operating frequency of the reference signal. A second parameter of the first reference signal is different from a second parameter of the second reference signal. It is also understood that a carrier frequency of the first transmitting device is different from a carrier frequency of the second transmitting device.

As described above, the first phase difference is for the first transmitting device and the second transmitting device. The receiving device determines the target phase difference based on the first phase difference and the first difference. The first difference is a difference between the first parameter of the first transmitting device and the first parameter of the second transmitting device. In an example in which the first parameter includes the initial phase, the first difference includes a difference (denoted as a difference 1) between the initial phase of the first transmitting device and the initial phase of the second transmitting device. In an example in which the first parameter includes a hardware delay, the first difference includes a difference (denoted as a difference 2) between the hardware delay of the first transmitting device and the hardware delay of the second transmitting device. In an example in which the first parameter includes a clock error, the first difference includes a difference (denoted as a difference 3) between the clock error of the first transmitting device and the clock error of the second transmitting device.

In some embodiments, the first parameter includes more of an initial phase, a hardware delay, and a clock error. If the first parameter includes multiple parameters, the first difference includes a sum of the multiple differences. For example, if the first parameter includes an initial phase and a hardware delay, the first difference includes a sum of the difference 1 and the difference 2. For another example, if the first parameter includes a hardware delay and a clock error, the first difference includes a sum of the difference 2 and the difference 3. For another example, if the first parameter includes an initial phase and a clock error, the first difference includes a sum of the difference 1 and the difference 2. For another example, if the first parameter includes an initial phase, a hardware delay, and a clock error, the first difference includes a sum of the difference 1, the difference 2, and the difference 3.

In some embodiments, the receiving device calculates a difference between the first phase difference and the first difference to obtain the target phase difference. For example, the target phase difference=the first phase difference−the first difference.

In some embodiments, the impact of the clock error of the transmitting device on positioning is ignored. If the first parameter includes the hardware delay and the initial phase, the target phase difference is calculated from the following expression.

$$Target phase difference = {ϕ}_{r , i}^{s 1} - {ϕ}_{r , i}^{s 2} - ( - {φ}_{i}^{s 1} - {δ}_{i}^{s 1} ) + ( - {φ}_{i}^{s 2} - {δ}_{i}^{s 2} )$$

where

$${ϕ}_{r , i}^{s 1}$$

represents the first phase for the first transmitting device,

$${ϕ}_{r , i}^{s 2}$$

represents the second phase for the second transmitting device,

$${ϕ}_{r , i}^{s 1} - {ϕ}_{r , i}^{s 2}$$

represents the first phase difference,

$${φ}_{i}^{s 1}$$

represents the initial phase of the first transmitting device,

$${φ}_{i}^{s 2}$$

represents the initial phase of the second transmitting device,

$${δ}_{i}^{s 1}$$

represents the hardware delay of the first transmitting device, and

$${δ}_{i}^{s 2}$$

represents the hardware delay of the second transmitting device.

In some implementations, the first parameter is sent to the receiving device by one or more of the following devices: a transmitting device, a base station, or a positioning device.

The foregoing is described by an example in which the receiving device calculates a target phase difference, and the target phase difference is calculated by the positioning device. The following describes the solutions in the embodiments of this application from a perspective of a positioning device with reference to FIG. 5. The solution shown in FIG. 5 is similar to the solution shown in FIG. 4. For a solution that is not described in detail, reference can be made to the foregoing description. For example, in some implementations, a manner in which the positioning device calculates the target phase difference is similar to a manner in which the receiving device calculates the target phase difference. For a solution not described in detail below, reference can be made to the foregoing description.

Referring to FIG. 5, in step S510, the positioning device receives the first information. The first information indicates a first parameter of the transmitting device, and the first parameter is related to positioning of the receiving device.

In some embodiments, the first information is sent by the transmitting device to the positioning device, or is sent by the transmitting device to the positioning device via the receiving device. In some implementation manners, the first information is sent to the positioning device after the positioning device requests. For example, the positioning device transmits a request message to the transmitting device, and the transmitting device transmits the first information to the positioning device after receiving the request message.

In step S520, the positioning device receives second information, where the second information includes a first phase difference for multiple transmitting devices.

In some embodiments, the second information is sent by the transmitting device to the positioning device, and is also sent by the receiving device to the positioning device. In some implementations, the second information is sent to the positioning device after the positioning device requests. For example, the positioning device transmits a request message to the receiving device, and the receiving device transmits the second information to the positioning device after receiving the request message.

In step S530, the positioning device processes, based on the first parameter, the first phase difference for the multiple transmitting devices to obtain the target phase difference. The target phase difference is for positioning the receiving device.

In some implementations, the first parameter includes one or more of the following: an initial phase, a hardware delay, or a clock error.

In some implementations, the multiple transmitting devices include a first transmitting device and a second transmitting device, a frequency of a reference signal sent by the first transmitting device is equal to a frequency of a reference signal sent by the second transmitting device. The first phase difference is a phase difference between the first transmitting device and the second transmitting device. The positioning device calculates a difference between the first phase difference and the first difference to obtain the target phase difference, where the first difference is a difference between a first parameter of the first transmitting device and a first parameter of the second transmitting device.

In some implementations, the first parameter includes a hardware delay and an initial phase, and the target phase difference is determined from the following expression.

$$Target phase difference = {ϕ}_{r , i}^{s 1} - {ϕ}_{r , i}^{s 2} - ( - {φ}_{i}^{s 1} - {δ}_{i}^{s 1} ) + ( - {φ}_{i}^{s 2} - {δ}_{i}^{s 2} )$$

where

$${ϕ}_{r , i}^{s 1}$$

represents the first phase for the first transmitting device,

$${ϕ}_{r , i}^{s 2}$$

represents the second phase for the second transmitting device,

$${ϕ}_{r , i}^{s 1} - {ϕ}_{r , i}^{s 2}$$

represents the first phase difference,

$${φ}_{i}^{s 1}$$

represents the initial phase of the first transmitting device,

$${φ}_{i}^{s 2}$$

represents the initial phase of the second transmitting device,

$${δ}_{i}^{s 1}$$

represents the hardware delay of the first transmitting device, and

$${δ}_{i}^{s 2}$$

represents the hardware delay of the second transmitting device.

In some implementations, the first parameter is sent to the positioning device by one or more of the following devices: a transmitting device, a receiving device, a base station, or a positioning reference unit.

FIG. 6 shows the positioning method according to another embodiment of this application. FIG. 6 is a description of the solution in this embodiment of this application from a perspective of a transmitting device. It is understood that the method shown in FIG. 6 is similar to the methods shown in FIG. 4 and FIG. 5. For content that is not described in detail, reference can be to the foregoing descriptions in FIG. 4 and FIG. 5.

Referring to FIG. 6, in step S610, the transmitting device transmits first information to the positioning device, where the first information indicates a first parameter of the transmitting device. The first parameter is related to positioning of the receiving device, or the first parameter can be used to position the receiving device.

After receiving the first information, the positioning device locates the receiving device based on the first information (or the first parameter). For example, the positioning device determines the foregoing described target phase difference based on the first information, and locates the receiving device based on the target phase difference.

In some implementations, the receiving device transmits the first phase and the second phase to the positioning device. The first phase is obtained by the receiving device measuring the first reference signal sent by the first transmitting device. The second phase is obtained by the receiving device measuring the second reference signal sent by the second transmitting device. After receiving the first phase and the second phase, the positioning device determines the target phase difference based on the first parameter. The positioning device processes the first phase and the second phase in a similar manner to the receiving device in FIG. 4, and thus in not described in detail here.

In some implementations, the receiving device also transmits the difference between the first phase and the second phase to the positioning device. The positioning device processes the difference based on the first parameter to obtain the target phase difference. The positioning device processes the difference in a similar manner to the receiving device in FIG. 4, and thus is not described in detail here.

In some embodiments, the first parameter includes one or more of the following: an initial phase, a hardware delay, a clock error, a difference between an initial phase of a first transmitting device and an initial phase of a second transmitting device, a difference between a hardware delay of the first transmitting device and a hardware delay of the second transmitting device, a difference between a clock error of the first transmitting device and a clock error of the second transmitting device, a second parameter related to a reference signal sent by the transmitting device, or a first indication information.

In some implementations, the first indication information may indicate whether the second parameter of the first reference signal is the same as the second parameter of the second reference signal. The first reference signal is sent by the first transmitting device, and the second reference signal is sent by the second transmitting device. In some implementations, the second parameter includes a wavelength and/or a frequency.

In some implementations, if the first indication information indicates that the second parameter of the first reference signal is the same as the second parameter of the second reference signal, the positioning device locates the receiving device according to the solution described above. If the first indication information indicates that the second parameter of the first reference signal is different from the second parameter of the second reference signal, the positioning device locates the receiving device according to the solution of different operating frequencies of the reference signals described below.

### 2. Reference Signals Having Different Operating Frequencies

In the process of positioning the receiving device, the second parameters (such as wavelengths or frequencies) of the reference signals sent by different transmitting devices may be different. In other words, the frequencies of the reference signals sent by different transmitting devices are different, or the wavelengths of the reference signals sent by different transmitting devices are different. In this case, positioning the receiving device directly based on the measured phase difference without taking into account the difference in the second parameters will result in inaccurate positioning.

When the frequencies of the reference signals sent by the transmitting devices s1 and s2 are different, the phase difference is calculated form the following expression by directly calculating a difference between phases measured by the receiving devices.

$${ϕ}_{r , 1}^{s 1} - {ϕ}_{r , 1}^{s 2} = \frac{[ {ρ}_{r}^{s 1} + c ( {dt}_{r} - {dt}^{s 1} ) - {I}_{r , i}^{s 1} + {T}_{r}^{s 1} + {ε}_{r , i}^{′ s 1} ]}{{λ}_{i , 1}} + ( {φ}_{r , i} + {δ}_{r , i} - {φ}_{i}^{s 1} - {δ}_{i}^{s 1} ) - \frac{[ {ρ}_{r}^{s 2} + c ( {dt}_{r} - {dt}^{s 2} ) - {I}_{r , i}^{s 2} + {T}_{r}^{s 2} + {ε}_{r , i}^{′ s 2} ]}{{λ}_{i , 2}} - ( {φ}_{r , i} + {δ}_{r , i} - {φ}_{i}^{s 2} - {δ}_{i}^{s 2} )$$

The following expression is obtained after the distance between the receiving device and the transmitting device is extracted.

$${ϕ}_{r , 1}^{s 1} - {ϕ}_{r , 1}^{s 2} = \frac{{ρ}_{r}^{s 1}}{{λ}_{i , 1}} - \frac{{ρ}_{r}^{s 2}}{{λ}_{i , 2}} + \frac{[ c ( {dt}_{r} - {dt}^{s 1} ) - {I}_{r , i}^{s 1} + {T}_{r}^{s 1} + {ε}_{r , i}^{′ s 1} ]}{{λ}_{i , 1}} + ( {φ}_{r , i} + {δ}_{r , i} - {φ}_{i}^{s 1} - {δ}_{i}^{s 1} ) - \frac{[ c ( {dt}_{r} - {dt}^{s 2} ) - {I}_{r , i}^{s 2} + {T}_{r}^{s 2} + {ε}_{r , i}^{′ s 2} ]}{{λ}_{i , 2}} - ( {φ}_{r , i} + {δ}_{r , i} - {φ}_{i}^{s 2} - {δ}_{i}^{s 2} )$$

The phase difference in the above expression fails to directly reflect the difference in the distance between the transmitting device and the receiving device. That is, the phase difference is the difference between the distance between the transmitter s1 and the receiver and the distance between the transmitter s2 and the receiver multiplied by different coefficients.

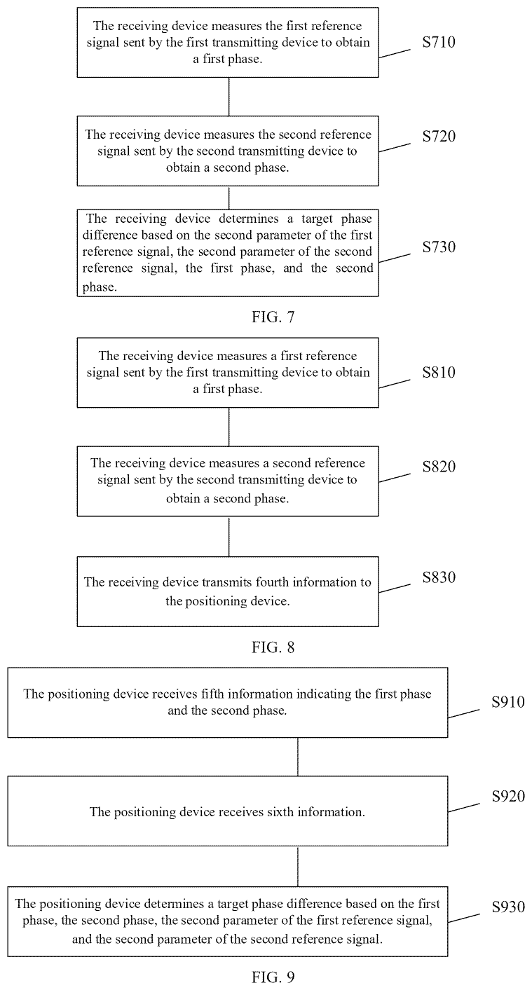

Based on this, an embodiment of this application provides a positioning method. A target phase difference is determined based on a second parameter, and then the receiving device is positioned based on the target phase difference, to improve the accuracy of the positioning result. The solution of the embodiment of this application is described in detail below in conjunction with FIGS. 6 and 7.

### First Embodiment

Referring to FIG. 7, in step S710, the receiving device measures the first reference signal sent by the first transmitting device to obtain a first phase.

In some embodiments, the receiving device receives the first reference signal sent by the first transmitting device, and measures the first reference signal to obtain the first phase. The first phase is, for example, the signal phase when the receiving device receives the first reference signal.

In step S720, the receiving device measures the second reference signal sent by the second transmitting device to obtain a second phase.

In some embodiments, the receiving device receives the second reference signal sent by the second transmitting device, and measures the second reference signal to obtain a second phase. The second phase is, for example, the signal phase when the receiving device receives the second reference signal.

The second parameter of the first reference signal is different from the second parameter of the second reference signal. The second parameter includes a wavelength and/or a frequency. For example, the wavelength of the first reference signal is different from the wavelength of the second reference signal. For another example, the frequency of the first reference signal is different from the frequency of the second reference signal. In some implementations, the frequency of the reference signal is also referred to as the operating frequency of the reference signal. The second parameter of the first reference signal is different from the second parameter of the second reference signal, which is also understood as the carrier frequency of the first transmitting device is different from the carrier frequency of the second transmitting device.

In step S730, the receiving device determines a target phase difference based on the second parameter of the first reference signal, the second parameter of the second reference signal, the first phase, and the second phase. The target phase difference can be used to locate the receiving device.

In some implementations, the receiving device processes the first phase and the second phase based on the second parameter of the first reference signal and the second parameter of the second reference signal to obtain the target phase difference. Taking the second parameter including a wavelength as an example, the receiving device processes the first phase and the second phase based on the wavelength of the first reference signal and the wavelength of the second reference signal to obtain the target phase difference.

In some embodiments, the receiving device determines a third phase based on the first phase and a third parameter. The third parameter is determined based on the second parameter of the first reference signal. The embodiment of this application does not specifically limit the method for determining the third parameter. In an example, the third parameter is the second parameter of the first reference signal. In another example, the third parameter is obtained by varying the second parameter of the first reference signal. For example, the third parameter is obtained by scaling the second parameter according to a certain ratio. For example, the third parameter is obtained by reducing the second parameter according to a certain ratio. Reducing the second parameter before performing subsequent calculations can reduce the amount of calculation and the time spent by the receiving device to process, which is conducive to reducing the positioning delay.

For example, for the same distance, the phases of the signals reaching the receiving devices are different when the wavelengths are different. The terminal device converts the phase of the target transmitting device into the phase of the reference transmitting point. The terminal device can convert the measured phase into the distance according to the actual wavelength, and then convert the distance into the phase according to the wavelength of the reference signal transmitted by the reference transmitting device, and report the converted phase to the positioning device. The positioning device calculates the distance and solves the position according to only the wavelength, that is, the wavelength of the reference signal transmitted by the reference transmitting point, without knowing the actual wavelength of the signal, thereby reducing the reporting amount, the calculation amount of the positioning server and the complexity of data maintenance.

For example, the third parameter is calculated from the following expression.

$$Third parameter = Second parameter / a$$

where a is a number greater than 1. a is an integer or a decimal. It should be noted that the second parameter in the above expression refers to the second parameter of the first reference signal.

In some embodiments, the receiving device determines the fourth phase based on the second phase and a fourth parameter. The fourth parameter is determined based on the second parameter of the second reference signal. The embodiment of this application does not specifically limit the method for determining the fourth parameter. In an example, the fourth parameter is the second parameter of the second reference signal. In another example, the fourth parameter is obtained by varying the second parameter of the second reference signal. For example, the fourth parameter is obtained by scaling the second parameter according to a certain ratio. For example, the fourth parameter is obtained by reducing the second parameter according to a certain ratio. Reducing the second parameter before performing subsequent calculations can reduce the amount of calculation and the time spent by the receiving device to process, which is conducive to reducing the positioning delay.

For example, the fourth parameter is calculated from the following expression.

$$Fourth parameter = Second parameter / a$$

where a is a number greater than 1. a is an integer or a decimal. It should be noted that the second parameter in the above expression refers to the second parameter of the second reference signal.

In some embodiments, the third parameter and the fourth parameter are determined in the same manner. For example, the third parameter is the second parameter of the first reference signal, and the fourth parameter is the second parameter of the second reference signal. For another example, the third parameter is obtained by reducing the second parameter of the first reference signal according to a first ratio, and the fourth parameter is obtained by reducing the second parameter of the second reference signal according to the first ratio.

In some embodiments, the third phase is determined based on the product of the first phase and the third parameter, and the fourth phase is determined based on the product of the second phase and the fourth parameter. For example, the third phase=the first phase*the third parameter, and the fourth phase=the second phase*the fourth parameter.

In some embodiments, the receiving device determines the target phase difference based on the difference between the third phase and the fourth phase. There are many ways to determine the target phase difference, which is not specifically limited in the embodiments of this application. In an example, the target phase difference is equal to the difference between the third phase and the fourth phase. In another example, the target phase difference is obtained after a certain processing is performed on the difference between the third phase and the fourth phase. This is described in detail below.

The following first introduces the example that the third parameter and the fourth parameter are both wavelengths. That is, the third parameter is the wavelength of the first reference signal, and the fourth parameter is the wavelength of the second reference signal.

In some implementations, the target phase difference is calculated from the following expression.

$$Target phase difference = {λ}_{i , 1} {ϕ}_{r , i}^{s 1} - {λ}_{i , 2} {ϕ}_{r , i}^{s 2}$$

where λ_{i,1} represents the wavelength of the first transmitting device, λ_{i,2} represents the wavelength of the second transmitting device,

$${ϕ}_{r , i}^{s 1}$$

represents the first phase, and

$${ϕ}_{r , i}^{s 2}$$

represents the second phase.

Combined with the above expression, the expression of calculating the target phase difference is converted as follows.

$$Target phase difference = {λ}_{i , 1} {ϕ}_{r , i}^{s 1} - {λ}_{i , 2} {ϕ}_{r , i}^{s 2} = {ρ}_{r}^{s 1} + c ( {dt}_{r} - {dt}^{s 1} ) - {I}_{r , i}^{s 1} + {T}_{r}^{s 1} + {ε}_{r , i}^{′ s 1} + {λ}_{i , 1} ( {φ}_{r , i} + {δ}_{r , i} - {φ}_{i}^{s 1} - {δ}_{i}^{s 1} ) - [ {ρ}_{r}^{s 2} + c ( {dt}_{r} - d {t}^{s 2} ) - {I}_{r , i}^{s 2} + {T}_{r}^{s 2} + {ε}_{r , i}^{′ s 2} ] - {λ}_{i , 2} ( {φ}_{r , i} + {δ}_{r , i} - {φ}_{i}^{s 2} - {δ}_{i}^{s 2} )$$

Furthermore, the above expression is converted as follows.

$$Target phase difference = {λ}_{i , 1} {ϕ}_{r , i}^{s 1} - {λ}_{i , 2} {ϕ}_{r , i}^{s 2} = {ρ}_{r}^{s 1} + c ( {dt}_{r} - {dt}^{s 1} ) - {I}_{r , i}^{s 1} + {T}_{r}^{s 1} + {ε}_{r , i}^{′ s 1} + {λ}_{i , 1} ( {φ}_{r , i} + {δ}_{r , i} - {φ}_{i}^{s 1} - {δ}_{i}^{s 1} ) - [ {p}_{r}^{s 2} + c ( {dt}_{r} - {dt}^{s 1} ) - {I}_{r , i}^{s 1} + {T}_{r}^{s 1} + {ε}_{r , i}^{′ s 1} ] - {λ}_{i , 2} ( {φ}_{r , i} + {δ}_{r , i} - {φ}_{i}^{s 2} - {δ}_{i}^{s 2} )$$

When the frequencies of the reference signals sent by the first transmitting device and the second transmitting device are not much different, the ionospheric delays of the first transmitting device and the second transmitting device are slightly different, and the tropospheric delays of the first transmitting device and the second transmitting device are slightly different, then the above expression is converted as follows by eliminating the ionospheric delay and the tropospheric delay.

$${λ}_{i , 1} {ϕ}_{r , i}^{s 1} - {λ}_{i , 2} {ϕ}_{r , i}^{s 2} = {ρ}_{r}^{s 1} - {cdt}^{s 1} + {ε}_{r , i}^{′ s 1} + {λ}_{i , 1} ( {φ}_{r , i} + {δ}_{r , i} - {φ}_{i}^{s 1} - {δ}_{i}^{s 1} ) - [ {ρ}_{r}^{s 2} - {cdt}^{s 2} + {ε}_{r , i}^{′ s 2} ] - {λ}_{i , 2} ( {φ}_{r , i} + {δ}_{r , i} - {φ}_{i}^{s 2} - {s}_{i}^{s 2} )$$

The initial phase and the hardware delay of the receiving device are combined, and then the above expression is converted into the following.

$${λ}_{i , 1} {ϕ}_{r , i}^{s 1} - {λ}_{i , 2} {ϕ}_{r , i}^{s 2} = ( {λ}_{i , 1} - {λ}_{i , 2} ) ( {φ}_{r , i} + {δ}_{r , i} ) + {ρ}_{r}^{s 1} - c d {t}^{s 1} + {ε}_{r , i}^{′ s 1} + {λ}_{i , 1} ( - {φ}_{i}^{s 1} - {δ}_{i}^{s 1} ) - [ {ρ}_{r}^{s 2} - c d {t}^{s 2} + {ε}_{r , i}^{′ s 2} ] - {λ}_{i , 2} ( - {φ}_{i}^{s 2} - {δ}_{i}^{s 2} )$$

It can be seen from the above expression that the embodiment of this application introduces the second parameter so that the target phase difference basically reflects the distance information between the receiving device and the transmitting device, thereby improving the positioning accuracy.

In some implementations, the receiving device determines the target phase difference based on the difference (recorded as the first difference) between the third phase and the fourth phase and the fifth parameter of the receiving device. The fifth parameter includes the hardware delay and/or the initial phase. Considering the fifth parameter of the receiving device in the positioning process can reduce the influence of the fifth parameter on the positioning accuracy, which is conducive to improving the positioning accuracy.

In an example, the fifth parameter includes the hardware delay and the initial phase, and the target phase difference is calculated from the following expression.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) ( {φ}_{r , i} + {δ}_{r , i} )$$

where λ_{i,1} represents the wavelength of the first transmitting device, λ_{i,2} represents the wavelength of the second transmitting device,

$${ϕ}_{r , i}^{s 1}$$

represents the first phase,

$${ϕ}_{r , i}^{s 2}$$

represents the second phase, φ_{r,i} represents the initial phase of the receiving device, and δ_{r,i} represents the hardware delay of the receiving device.

Combined with the above expression, the expression of calculating the target phase difference is converted as follows.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) ( {φ}_{r , i} + {δ}_{r , i} ) = {ρ}_{r}^{s 1} - {cdt}^{s 1} + {ε}_{r , i}^{′ s 1} + {λ}_{i , 1} ( - {φ}_{i}^{s 1} - {δ}_{i}^{s 1} ) - [ {ρ}_{r}^{s 2} - c d {t}^{s 2} + {ε}_{r , i}^{′ s 2} ] - {λ}_{i , 2} ( - {φ}_{i}^{s 2} - {δ}_{i}^{s 2} )$$

It can be seen from the above expression that the embodiment of this application improves positioning accuracy by eliminating the error caused by the hardware delay and the initial phase in the phase difference, so that the target phase difference basically reflects the distance information between the receiving device and the transmitting device, thereby improving the positioning accuracy.

For example, the fifth parameter includes the hardware delay, and the target phase difference is calculated from the following expression.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) * {δ}_{r , i}$$

where λ_{i,1} represents the wavelength of the first transmitting device, λ_{i,2} represents the wavelength of the second transmitting device,

$${ϕ}_{r , i}^{s 1}$$

represents the first phase,

$${ϕ}_{r , i}^{s 2}$$

represents the second phase, and δ_{r,i} represents the hardware delay of the receiving device.

For example, the fifth parameter includes the initial phase, and the target phase difference is calculated from the following expression.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) * {φ}_{r , i}$$

where λ_{i,1} represents the wavelength of the first transmitting device, λ_{i,2} represents the wavelength of the second transmitting device,

$${ϕ}_{r , i}^{s 1}$$

represents the first phase,

$${ϕ}_{r , i}^{s 2}$$

represents the second phase, and φ_{r,i} represents the initial phase of the receiving device.

In some embodiments, a sixth parameter (such as one or more of a clock error, a hardware delay or an initial phase) of the transmitting device also affects the positioning accuracy. Therefore, calculating the target phase difference based on the sixth parameter can reduce the impact of the sixth parameter on the positioning accuracy and improve the positioning accuracy.

In some embodiments, the receiving device determines the target phase difference based on the first difference, the fifth parameter of the receiving device, the sixth parameter of the first transmitting device, and the sixth parameter of the second transmitting device.

In some implementations, the target phase difference is calculated from the following expression.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) ( {φ}_{r , i} + {δ}_{r , i} ) - Δ {∅}_{s , e}$$

In some embodiments, Δ∅_{s,e} is calculated from the following expression.

$${Δ∅}_{s , e} = c ( {dt}^{s 2} - {dt}^{s 1} ) + {λ}_{i , 1} ( - {φ}_{i}^{s 1} - {δ}_{i}^{s 1} ) - {λ}_{i , 2} ( - {φ}_{i}^{s 2} - {δ}_{i}^{s 2} )$$

λ_{i,1} represents the wavelength of the first transmitting device, λ_{i,2} represents the wavelength of the second transmitting device,

$${ϕ}_{r , i}^{s 1}$$

represents the first phase,

$${ϕ}_{r , i}^{s 2}$$

represents the second phase, φ_{r,i} represents the initial phase of the receiving device, δ_{r,i} represents the hardware delay of the receiving device, c represents the speed of light, dt^{s2} represents the clock error of the second transmitting device, dt^{s1} represents the clock error of the first transmitting device,

$${φ}_{i}^{s 1}$$

represents the initial phase of the first transmitting device,

$${δ}_{i}^{s 1}$$

represents the hardware delay of the first transmitting device,

$${φ}_{i}^{s 2}$$

represents the initial phase of the second transmitting device, and

$${δ}_{i}^{s 2}$$

represents the hardware delay of the second transmitting device.

It is understood that the above expression for determining the target phase difference (e.g., Δ∅_{s,e}) is only an example, and the target phase difference is also determined from other expressions, and the embodiments of this application do not specifically limit this.

For example, if the sixth parameter includes the clock error, the target phase difference is calculated from the following expression.

$$Δ {∅}_{s , e} = c ( {dt}^{s 2} - {dt}^{s 1} )$$

For another example, if the sixth parameter includes the hardware delay, the target phase difference is calculated from the following expression.

$${Δ∅}_{s , e} = - {λ}_{i , 2} ( - {φ}_{i}^{s 2} - {δ}_{i}^{s 2} )$$

For another example, if the sixth parameter includes an initial phase, the target phase difference is calculated from the following expression.

$$Δ {∅}_{s , e} = {λ}_{i , 1} ( - {φ}_{i}^{s 1} - {δ}_{i}^{s 1} )$$

For another example, if the sixth parameter includes the clock error and the hardware delay, the target phase difference is calculated from the following expression.

$$Δ {∅}_{s , e} = c ( d {t}^{s 2} - d {t}^{s 1} ) - {λ}_{i , 2} ( - {φ}_{i}^{s 2} - {δ}_{i}^{s 2} )$$

For another example, if the sixth parameter includes the clock error and the initial phase, the target phase difference is calculated from the following expression.

$$Δ {∅}_{s , e} = c ( d {t}^{s 2} - d {t}^{s 1} ) + ( - {φ}_{i}^{s 1} - {δ}_{i}^{s 1} )$$

For another example, if the sixth parameter includes the hardware delay and the initial phase, the target phase difference is calculated from the following expression.

$${Δ∅}_{s , e} = ( - {φ}_{i}^{s 1} - {δ}_{i}^{s 1} ) - {λ}_{i , 2} ( - {φ}_{i}^{s 2} - {δ}_{i}^{s 2} )$$

In some embodiments, the third parameter and/or the fourth parameter are/is determined based on the ratio of the wavelength of the first reference signal to the wavelength of the second reference signal. For example, the ratio of the third parameter to the fourth parameter is a first ratio, the ratio of the wavelength of the first reference signal to the wavelength of the second reference signal is a second ratio, and the first ratio is equal to the second ratio.

In some implementations, the target phase difference is calculated from the following expression.

$$Target phase difference = p {ϕ}_{r , i}^{s 1} - q {ϕ}_{r , i}^{s 2}$$

$${ϕ}_{r , i}^{s 1}$$

represents the first phase,

$${ϕ}_{r , i}^{s 2}$$

represents the second phase, p represents the third parameter, and q represents the fourth parameter.

In some implementations, one of the third parameter and the fourth parameter is 1. Normalizing one of the third parameter and the fourth parameter can greatly reduce the amount of calculation for determining the target phase difference, and is conducive to reducing the positioning delay. For example, assuming that the second ratio is 2, the third parameter is 2, and the fourth parameter is 1.

In some implementations, the third parameter and the fourth parameter are integers or decimals. For example, assuming that the second ratio is 1.5, and then the third parameter is 1.5, the fourth parameter is 1, or the third parameter is 3, and the fourth parameter is 2. Setting the third parameter and the fourth parameter to integers can be helpful to reduce the amount of calculation for determining the target phase difference and reduce the positioning delay.

In some embodiments, the third parameter and the fourth parameter are also referred to as weights.

In some embodiments, if the target phase difference is determined based on the third parameter and the fourth parameter (e.g., p and q above), the receiving device transmits third information to the positioning device. The third information indicates the third parameter and/or the fourth parameter. After receiving the third information, the positioning device processes the target phase difference based on the third information to locate the receiving device.

### Second Embodiment

FIG. 8 shows a positioning method according to an embodiment of this application. A phase for a transmitting device and a second parameter (such as a wavelength and/or a frequency) of a reference signal sent by the transmitting device are sent to a positioning device, so that the positioning device processes the phase of the transmitting device based on the second parameter, thereby locating the receiving device.

Referring to FIG. 8, in step S810, the receiving device measures a first reference signal sent by the first transmitting device to obtain a first phase.

In some embodiments, the receiving device receives the first reference signal sent by the first transmitting device, and measures the first reference signal to obtain the first phase. The first phase is, for example, the signal phase when the receiving device receives the first reference signal.

In step S820, the receiving device measures a second reference signal sent by the second transmitting device to obtain a second phase.

In some embodiments, the receiving device receives the second reference signal sent by the second transmitting device, and measures the second reference signal to obtain a second phase. The second phase is, for example, the signal phase when the receiving device receives the second reference signal.

The second parameter of the first reference signal is different from the second parameter of the second reference signal. The second parameter includes a wavelength and/or a frequency. For example, the wavelength of the first reference signal is different from the wavelength of the second reference signal. For another example, the frequency of the first reference signal is different from the frequency of the second reference signal. In some implementations, the frequency of the reference signal is also referred to as the operating frequency of the reference signal. The second parameter of the first reference signal is different from the second parameter of the second reference signal, which is also understood as the carrier frequency of the first transmitting device is different from the carrier frequency of the second transmitting device.

In step S830, the receiving device transmits fourth information to the positioning device. The fourth information may indicate the following information: the first phase and the second phase, the second parameter of the first reference signal and the second parameter of the second reference signal.

The fourth information can be used to locate the receiving device. For example, the positioning device processes the first phase and the second phase based on the second parameter of the first reference signal and the second parameter of the second reference signal to locate the receiving device. The positioning device processes the phase in a similar manner to the receiving device in the first embodiment above, and thus is not detailed here for the sake of brevity. For example, the positioning device determines the target phase difference based on the fourth information, and the determination method of the target phase difference is similar to that in the first embodiment.

The second parameter is proactively sent by the receiving device to the positioning device, and is also sent upon the request of the positioning device. In some implementations, the receiving device receives a request message sent by the positioning device, and the request message is used to request the second parameter of the first reference signal and/or the second parameter of the second reference signal. In response to the request message, the receiving device transmits the second parameter of the first reference signal and the second parameter of the second reference signal to the positioning device.

FIG. 9 is another positioning according to an embodiment of this application. FIG. 9 introduces the solution of the embodiment of this application from the perspective of the positioning device.

Referring to FIG. 9, in step S910, the positioning device receives fifth information indicating the first phase and the second phase.

In some embodiments, the fifth information is sent by the receiving device to the positioning device, or is also sent by the transmitting device to the positioning device. In some implementations, the fifth information is sent to the positioning device after the positioning device requests it. For example, the positioning device transmits a request message to the receiving device, and the receiving device transmits the fifth information to the positioning device after receiving the request message.

The first phase and the second phase here are the same as the first phase and the second phase mentioned above, and the relevant content can be found in the above description. For example, the first phase is obtained by measuring the first reference signal sent by the first transmitting device, and the second phase is obtained by measuring the second reference signal sent by the second transmitting device. The second parameters of the first reference signal and the second reference signal are different. The second parameter includes a wavelength and/or a frequency.

In step S920, the positioning device receives sixth information. The sixth information indicates a second parameter of the first reference signal and a second parameter of the second reference signal.

In some implementations, the sixth information is sent by the first device to the positioning device, and the first device includes one or more of the following: a receiving device, a first transmitting device, a second transmitting device, or a base station.

In step S930, the positioning device determines a target phase difference based on the first phase, the second phase, the second parameter of the first reference signal, and the second parameter of the second reference signal. The target phase difference can be used to locate the receiving device.

The positioning device processes the phase in a similar manner to the receiving device in the first embodiment above, and thus is described here for brevity. For example, the positioning device determines the target phase difference based on the fourth information, and the target phase difference is determined in a similar manner to the first embodiment.

In some embodiments, if the sixth information is sent by the receiving device to the positioning device, the fifth information and the sixth information are carried in the same message. For example, the receiving device transmits a first message to the positioning device, and the first message includes the fifth information and the sixth information. Carrying the fifth information and the sixth information in the same message can reduce the signaling overhead.

In some embodiments, the sixth information is sent periodically. For example, the first device periodically transmits the sixth information to the positioning device.

In other embodiments, the sixth information is sent when the first condition is met. The first condition includes one or more of the following: a change in the second parameter of the first reference signal, or a change in the second parameter of the second reference signal. Transmitting the sixth information to the positioning device when the second parameter changes can reduce signaling overhead.

In some implementations, the sixth information is sent when the wavelength (or frequency) of the first reference signal changes. In some implementations, the sixth information is sent when the wavelength (or frequency) of the second reference signal changes.

In some embodiments, the sixth information is sent at the request of the positioning device. For example, before receiving the sixth information, the positioning device transmits a request message, which is used to request the second parameter of the first reference signal and/or the second parameter of the second reference signal. For example, the positioning device transmits a request message to the first device, and the first device transmits the sixth information to the positioning device on receipt of the request message.

It should be noted that in some of the above descriptions, the second parameter is replaced by the second parameter of the first reference signal and/or the second parameter of the second reference signal. In addition, in some descriptions, the processing of the parameter refers to the processing of a value of the parameter.

It should be noted that although the above is introduced separately for different embodiments, different embodiments can be used in combination with each other, for example, related contents between different embodiments are referenced to each other.

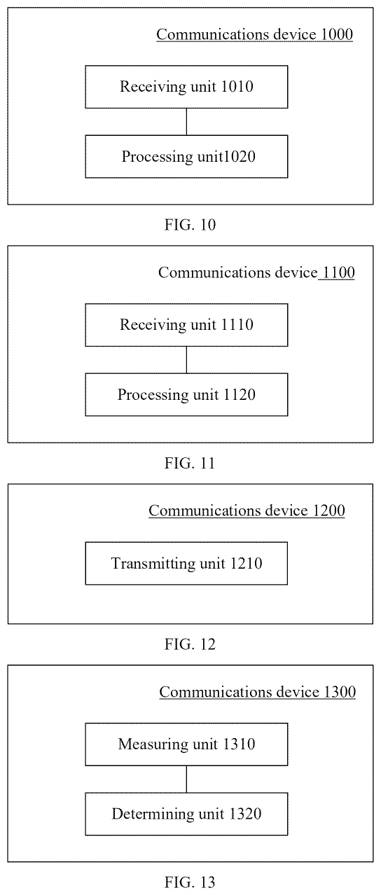

The method embodiments of this application are described in detail above in conjunction with FIGS. 1 to 9, and the device embodiments of this application are described in detail below in conjunction with FIGS. 10 to 16. It should be understood that the description of the method embodiments corresponds to the description of the device embodiments. Therefore, for the part not described in detail, reference can be made to the previous method embodiments.

FIG. 10 is a schematic block diagram of a communications device according to an embodiment of this application. The communications device 1000 shown in FIG. 10 is a receiving device. The receiving device is any of the receiving devices described above. The receiving device includes a receiving unit 1010 and a processing unit 1020.

The receiving unit 1010 is configured to receive first information, where the first information indicates a first parameter of a transmitting device, and the first parameter is related to positioning of the receiving device.

The processing unit 1020 is configured to process a first phase difference for multiple transmitting devices based on the first parameter, to obtain a target phase difference, where the target phase difference is for locating the receiving device.

In some implementations, the first parameter includes one or more of the following: an initial phase, a hardware delay, or a clock error.

In some implementations, the multiple transmitting devices include a first transmitting device and a second transmitting device, and the frequencies of the reference signals sent by the first transmitting device and the second transmitting device are equal, and the first phase difference is a phase difference between the first transmitting device and the second transmitting device. The processing unit is configured to: subtract the first phase difference from the first difference to obtain the target phase difference, where the first difference is the difference between the first parameter of the first transmitting device and the first parameter of the second transmitting device.

In some implementations, the communications device further includes a measuring unit. The measuring unit is configured to measure a first reference signal sent by the first transmitting device to obtain a first phase, and to measure a second reference signal sent by the second transmitting device to obtain a second phase. The processing unit is configured to calculate a difference between the first phase and the second phase to obtain the first phase difference.

In some implementations, the first parameter includes a hardware delay and an initial phase, and the target phase difference is calculated from the following expression.

$$Target phase difference = {ϕ}_{r , i}^{s 1} - {ϕ}_{r , i}^{s 2} - ( - {φ}_{i}^{s 1} - {δ}_{i}^{s 1} ) + ( - {φ}_{i}^{s 2} - {δ}_{i}^{s 2} )$$

where

$${ϕ}_{r , i}^{s 1}$$

represents the first phase for the first transmitting device,

$${ϕ}_{r , i}^{s 2}$$

represents the second phase for the second transmitting device,

$${ϕ}_{r , i}^{s 1} - {ϕ}_{r , i}^{s 2}$$

represents the first phase difference,

$${φ}_{i}^{s 1}$$

represents the initial phase of the first transmitting device,

$${φ}_{i}^{s 2}$$

represents the initial phase of the second transmitting device,

$${δ}_{i}^{s 1}$$

represents the hardware delay of the first transmitting device, and

$${δ}_{i}^{s 2}$$

represents the hardware delay of the second transmitting device.

In some implementations, the first parameter is sent to the receiving device by one or more of the following devices: a transmitting device, a base station, or a positioning device.

FIG. 11 is a schematic block diagram showing a communications device according to an embodiment of this application. The communications device 1100 shown in FIG. 11 is a positioning device. The positioning device is any positioning device as described above. The positioning device includes a receiving unit 1110 and a processing unit 1120.

The receiving unit 1110 is configured to receive first information, where the first information indicates a first parameter of a transmitting device, and the first parameter is related to positioning of the receiving device. The receiving unit is further configured to receive second information sent by the receiving device, where the second information includes a first phase difference for multiple transmitting devices.

The processing unit 1120 is configured to process, based on the first parameter, a first phase difference for multiple transmitting devices to obtain a target phase difference, where the target phase difference is for positioning the receiving device.

In some implementations, the first parameter includes one or more of the following: an initial phase, a hardware delay, or a clock error.

In some implementations, the multiple transmitting devices include a first transmitting device and a second transmitting device, a frequency of a reference signal sent by the first transmitting device is equal to a frequency of a reference signal sent by the second transmitting device. The first phase difference is a phase difference between the first transmitting device and the second transmitting device. The processing unit is configured to calculate a difference between the first phase difference and a first difference to obtain the target phase difference. The first difference is a difference between a first parameter of the first transmitting device and a first parameter of the second transmitting device.

In some implementations, the first parameter includes a hardware delay and an initial phase, and the target phase difference is determined from the following expression.

$$Target phase difference = {ϕ}_{r , i}^{s 1} - {ϕ}_{r , i}^{s 2} - ( - {φ}_{i}^{s 1} - {δ}_{i}^{s 1} ) + ( - {φ}_{i}^{s 2} - {δ}_{i}^{s 2} )$$

where

$${ϕ}_{r , i}^{s 1}$$

represents the first phase for the first transmitting device,

$${ϕ}_{r , i}^{s 2}$$

represents the second phase for the second transmitting device,

$${ϕ}_{r , i}^{s 1} - {ϕ}_{r , i}^{s 2}$$

represents the first phase difference,

$${φ}_{i}^{s 1}$$

represents the initial phase of the first transmitting device,

$${φ}_{i}^{s 2}$$

represents the initial phase of the second transmitting device,

$${δ}_{i}^{s 1}$$

represents the hardware delay of the first transmitting device, and

$${δ}_{i}^{s 2}$$

represents the hardware delay of the second transmitting device.

In some implementations, the first parameter is sent to the positioning device by one or more of the following: a transmitting device, a receiving device, a base station, or a positioning reference unit.

FIG. 12 is a schematic block diagram showing a communications device according to an embodiment of this application. The communications device 1200 shown in FIG. 12 is a transmitting device. The transmitting device is any of transmitting devices as described above. The transmitting device includes a transmitting unit 1210.

The transmitting unit 1210 is configured to send first information to a positioning device, where the first information indicates a first parameter of the transmitting device, and the first parameter is related to positioning of the receiving device. The first parameter is used by the positioning device to process a first phase difference for multiple transmitting devices to obtain a target phase difference, and the target phase difference is for positioning the receiving device.

In some implementations, the first parameter includes one or more of the following: an initial phase, a hardware delay, a clock error, a second parameter related to a reference signal sent by a transmitting device, and first indication information. The first indication information indicates whether the second parameter of the first reference signal is the same as the second parameter of the second reference signal. The second parameter includes a wavelength and/or a frequency. The first reference signal is a reference signal sent by the first transmitting device, and the second reference signal is a reference signal sent by the second transmitting device.

FIG. 13 is a schematic block diagram showing a communications device according to an embodiment of this application. The communications device 1300 shown in FIG. 13 is a receiving device. The receiving device is any of the receiving devices described above. The receiving device includes a measuring unit 1310 and a determining unit 1320.

The measuring unit 1310 is configured to measure a first reference signal sent by a first transmitting device to obtain a first phase, and to measure a second reference signal sent by a second transmitting device to obtain a second phase. The first reference signal and the second reference signal have different second parameters. The second parameter includes a wavelength and/or a frequency.

The determining unit 1320 is configured to determine a target phase difference based on the second parameter of the first reference signal, the second parameter of the second reference signal, the first phase, and the second phase. The target phase difference is for locating the receiving device.

In some implementations, the determining unit is configured to: determine a third phase based on the first phase and a third parameter, where the third parameter is determined based on the second parameter of the first reference signal; determine a fourth phase based on the second phase and a fourth parameter, where the fourth parameter is determined based on the second parameter of the second reference signal; and determine the target phase difference based on a difference between the third phase and the fourth phase.

In some implementations, the third phase is determined based on a product of the first phase and the third parameter, and the fourth phase is determined based on a product of the second phase and the fourth parameter.

In some implementations, the third parameter and the fourth parameter are both wavelengths.

In some implementations, the target phase difference is calculated from the following expression.

$$Target phase difference = {λ}_{i , 1} {ϕ}_{r , i}^{s 1} - {λ}_{i , 2} {ϕ}_{r , i}^{s 2}$$

where λ_{i,1} represents the wavelength of the first transmitting device, λ_{i,2} represents the wavelength of the second transmitting device,

$${ϕ}_{r , i}^{s 1}$$

represents the first phase, and

$${ϕ}_{r , i}^{s 2}$$

represents the second phase.

In some implementations, the determining unit is configured to determine the target phase difference based on a difference between the third phase and the fourth phase, and a fifth parameter of the receiving device. The fifth parameter includes a hardware delay and/or an initial phase.

In some implementations, the target phase difference is calculated from the following expression.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) ( {φ}_{r , i} + {δ}_{r , i} )$$

where λ_{i,1} represents the wavelength of the first transmitting device, λ_{i,2} represents the wavelength of the second transmitting device,

$${ϕ}_{r , i}^{s 1}$$

represents the first phase,

$${ϕ}_{r , i}^{s 2}$$

represents the second phase, φ_{r,i} represents the initial phase of the receiving device, and δ_{r,i} represents the hardware delay of the receiving device.

In some implementations, the determining unit is configured to determine the target phase difference based on a difference between the third phase and the fourth phase, a fifth parameter of the receiving device, a sixth parameter of the first transmitting device, and a sixth parameter of the second transmitting device. The sixth parameter includes one or more of the following parameters: a clock error, a hardware delay, or an initial phase.

In some implementations, the target phase difference is calculated from the following expression.

$$Target phase difference = {λ}_{i , 1} {ϕ}_{r , i}^{s 1} - {λ}_{i , 2} {ϕ}_{r , i}^{s 2} - ( {λ}_{i , 1} - {λ}_{i , 2} ) ( {φ}_{r , i} + {δ}_{r , i} ) - {Δ∅}_{s , e}$$

$${Δ∅}_{s , e} = c ( {dt}^{s 2} - {dt}^{s 1} ) + {λ}_{i , 1} ( - {φ}_{i}^{s 1} - {δ}_{i}^{s 1} ) - {λ}_{i , 2} ( - {φ}_{i}^{s 2} - {δ}_{i}^{s 2} )$$

λ_{i,1} represents the wavelength of the first transmitting device, λ_{i,2} represents the wavelength of the second transmitting device,

$${ϕ}_{r , i}^{s 1}$$

represents the first phase,

$${ϕ}_{r , i}^{s 2}$$

represents the second phase, φ_{r,i} represents the initial phase of the receiving device, δ_{r,i} represents the hardware delay of the receiving device, c represents the speed of light, dt^{s2} represents the clock error of the second transmitting device, dt^{s1} represents the clock error of the first transmitting device,

$${φ}_{i}^{s 1}$$

represents the initial phase of the first transmitting device,

$${δ}_{i}^{s 1}$$

represents the hardware delay of the first transmitting device,

$${φ}_{i}^{s 2}$$

represents the initial phase of the second transmitting device, and

$${δ}_{i}^{s 2}$$

represents the hardware delay of the second transmitting device.

In some implementations, the ratio of the third parameter to the fourth parameter is a first ratio, the ratio of the wavelength of the first reference signal to the wavelength of the second reference signal is a second ratio, and the first ratio is equal to the second ratio.

In some implementations, the communications device further includes: a transmitting unit, configured to send third information to the positioning device. The third information indicates the third parameter and/or the fourth parameter.

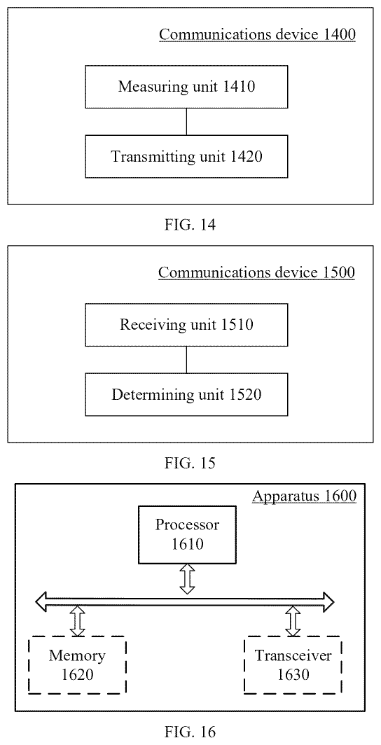

FIG. 14 is a schematic block diagram showing a communications device according to an embodiment of this application. The communications device 1400 shown in FIG. 14 is a receiving device. The receiving device is any of the receiving devices described above. The receiving device includes a measuring unit 1410 and a transmitting unit 1420.

The measuring unit 1410 is configured to measure a first reference signal sent by a first transmitting device to obtain a first phase, and to measure a second reference signal sent by a second transmitting device to obtain a second phase. The first reference signal and the second reference signal have different second parameters. The second parameter includes a wavelength and/or a frequency.

The transmitting unit 1420 is configured to send fourth information to a positioning device, where the fourth information indicates the first phase and the second phase, the second parameter of the first reference signal, and the second parameter of the second reference signal. The fourth information is for locating the receiving device.

In some implementations, the communications device further includes: a receiving unit, configured to receive a request message sent by the positioning device before transmitting the fourth information to the positioning device. The request message is used to request the second parameter of the first reference signal and/or the second parameter of the second reference signal.

FIG. 15 is a schematic block diagram showing a communications device according to an embodiment of this application. The communications device 1500 shown in FIG. 15 is a positioning device. The positioning device is any positioning device described above. The positioning device includes a receiving unit 1510 and a determining unit 1520.

The receiving unit 1510 is configured to receive fifth information sent by a receiving device, where the fifth information indicates a first phase and a second phase. The first phase is obtained by measuring a first reference signal sent by a first transmitting device. The second phase is obtained by measuring a second reference signal sent by a second transmitting device. The first reference signal and the second reference signal have different second parameters. The second parameter includes a wavelength and/or a frequency. The receiving unit is further configured to receive sixth information, where the sixth information indicates the second parameter of the first reference signal and the second parameter of the second reference signal.

The determining unit 1520 is configured to determine a target phase difference based on the first phase, the second phase, the second parameter of the first reference signal, and the second parameter of the second reference signal. The target phase difference is for locating the receiving device.

In some implementations, the sixth information is sent to the positioning device by one or more of the following: the receiving device, the first transmitting device, the second transmitting device, or a base station.

In some implementations, the sixth information is sent to the positioning device by the receiving device, and the fifth information and the sixth information are carried in the same message.

In some implementations, the sixth information is sent periodically, or the sixth information is sent when a first condition is satisfied. The first condition includes one or more of the following: periodic transmission, a change in the second parameter of the first reference signal or a change in the second parameter of the second reference signal.

In some implementations, the communications device further includes: a transmitting unit, configured to send a request message before the sixth information is received. The request message is used to request the second parameter of the first reference signal and/or the second parameter of the second reference signal.

FIG. 16 is a schematic structural diagram showing a communications apparatus according to an embodiment of this application. The dotted line in FIG. 16 indicates that the unit or module is optional. The apparatus 1600 can be used to implement the method described in the above method embodiment. The apparatus 1600 is a chip or a communications device. The communications device is any of the communications devices described above. For example, the communication device is a receiving device or a positioning device.

The apparatus 1600 includes one or more processors 1610. The processor 1610 can support the apparatus 1600 to implement the method described in the above method embodiments. The processor 1610 is a general-purpose processor or a special-purpose processor. For example, the processor is a central processing unit (CPU). Alternatively, the processor is also other general-purpose processor, a digital signal processor (DSP), an application specific integrated circuit (ASIC), a field programmable gate arrays (FPGA) or other programmable logic device, a discrete gate or a transistor logic device, or a discrete hardware component. The general-purpose processor is a microprocessor or the processor is also any conventional processor, etc.

The apparatus 1600 further includes one or more memories 1620. The memory 1620 stores a program, which is executable by the processor 1610 so that the processor 1610 executes the method described in the above method embodiments. The memory 1620 is independent of the processor 1610 or integrated in the processor 1610.

The apparatus 1600 further includes a transceiver 1630. The processor 1610 communicates with other devices or chips through the transceiver 1630. For example, the processor 1610 exchanges data with other devices or chips through the transceiver 1630.

The embodiment of this application also provides a computer-readable storage medium for storing a program. The computer-readable storage medium can be applied to the communications device provided in the embodiments of this application, and the program causes a computer to execute the method executed by the communication devices in embodiments of this application.

The embodiment of this application also provides a computer program product. The computer program product includes a program. The computer program product can be applied to the communication device provided in the embodiment of this application, and the program causes a computer to execute the method performed by the communication device in embodiments of this application.

The embodiment of this application also provides a computer program. The computer program can be applied to the communications device according to the embodiment of this application, and the computer program causes a computer to execute the method executed by the communications device in embodiments of this application.

It should be understood that the terms “system” and “network” in this application may be used interchangeably. In addition, the terms used in this application are merely to explain specific embodiments of this application, and are not intended to limit this application. The terms “first”, “second”, “third”, and “fourth” in the specification, claims, and accompanying drawings of this application are used to distinguish between different objects, and are not used to describe a specific sequence. In addition, the terms “include”, “have” and any variations thereof are intended to cover the inclusion of non-exclusive.

In the embodiments of this application, the mentioned “indication” may be a direct indication, an indirect indication, or an association relationship. For example, A indicates B, which may indicate that A directly indicates B, for example, B may be obtained based on A. Alternatively, it may indicate that A indirectly indicates B, for example, A indicates C, and B may be obtained based on C. It may further indicate that there is an association relationship between A and B.

In the embodiments of this application, the term “include” refers to direct inclusion as well as indirect inclusion. Optionally, the term “include” mentioned in the embodiments of this application can be replaced with “indicates” or “is used to determine”. For example, “A includes B” can be replaced with “A indicates B” or “A is used to determine B”.

In the embodiments of this application, “B corresponding to A” indicates that B is associated with A, and B may be determined according to A. However, it should be further understood that determining B according to A does not mean determining B according to A only, and may further determine B according to A and/or other information.

In the embodiments of this application, the term “correspondence” may indicate that there is a direct correspondence or an indirect correspondence between the two, or may indicate an association relationship between the two, or may indicate a relationship with indication, configuration, and configuration.

In the embodiments of this application, “predefined” or “pre-configured” may be implemented in a manner in which a corresponding code, table, or other related information may be pre-stored in a device (for example, a terminal device or a network device). A specific implementation manner of this application is not limited. For example, a predefined definition may refer to a definition in a protocol.

In the embodiments of this application, the “protocol” may refer to a standard protocol in the communications field, for example, may include an LTE protocol, an NR protocol, and a related protocol applied to a future communications system. This is not limited in this application.

In the embodiments of this application, the term “and/or” is merely an association relationship that describes an associated object, and indicates that three relationships may exist. For example, A and/or B may indicate that A exists separately, A and B exist simultaneously, and B exists separately. In addition, the character “/” in this specification generally indicates that the associated object is a “or” relationship.

In various embodiments of this application, a sequence number of the foregoing processes does not mean a sequence of execution. The execution sequence of the processes should be determined according to functions and internal logic of the processes, and should not constitute any limitation on an implementation process of the embodiments of this application.

In the embodiments provided in this application, it should be understood that the disclosed system, apparatus, and method may be implemented in another manner. For example, the described apparatus embodiment is merely an example. For example, the unit division is merely logical function division. In actual implementation, there may be another division manner. For example, multiple units or components may be combined or integrated into another system, or some features may be ignored or not performed. On the other hand, the displayed or discussed mutual coupling or direct coupling or communication connection may be through some interfaces, indirect coupling or communication connection of the apparatus or unit, and may be in an electrical, mechanical, or other form.

The units described as separate parts may or may not be physically separate, and parts described as units may or may not be physical units, may be located in one place, or may be distributed on multiple network units. Some or all of the units may be selected according to an actual requirement to implement the objectives of the solutions in the embodiments.

In addition, functional units in the embodiments of this application may be integrated into one processing unit, or units may exist separately physically, or two or more units may be integrated into one unit.

In the above embodiments, all or part of them are implemented by software, hardware, firmware or any combination thereof. When software is used, the solution may be implemented in full or in part in the form of a computer program product. The computer program product includes one or more computer instructions. When the computer instructions are loaded and executed on the computer, a process or a function described in the embodiments of this application is completely or partially generated. The computer may be a general-purpose computer, a dedicated computer, a computer network, or another programmable apparatus. The computer instructions may be stored in a computer readable storage medium or transmitted from one computer readable storage medium to another computer readable storage medium. For example, the computer instructions may be transmitted from one website site, computer, server or data center to another website site, computer, server or data center in a wired (e.g., a coaxial cable, an optical fiber, a digital subscriber line (DSL)) or wireless (e.g., infrared, wireless, microwave) manner. The computer-readable storage medium is any available medium that can be read by a computer or a data storage device such as a server or a data center that includes one or more available media. The available medium is a magnetic medium (e.g., a floppy disk, a hard disk, a magnetic tape), an optical medium (e.g., a digital video disc (DVD)), or a semiconductor medium (e.g., a solid-state disk (SSD)).

The foregoing descriptions are merely specific implementations of this application, but are not intended to limit the protection scope of this application. Any change or replacement readily figured out by those skilled in the art within the technical scope disclosed in this application shall fall within the protection scope of this application. Therefore, the protection scope of this application shall be subject to the protection scope of the claims.

What is claimed is:

1. A positioning method, comprising:
receiving first information by a first device, wherein the first information indicates a first parameter of a second device, and the first parameter is related to positioning of the first device; and
processing, by the first device, a first phase difference for a plurality of second devices based on the first parameter, to obtain a target phase difference, wherein the target phase difference is used for positioning the first device.

2. The method according to claim 1, wherein the first parameter comprises one or more of the following: an initial phase, a hardware delay, or a clock error.

3. The method according to claim 2, wherein the plurality of second devices comprises a fourth device and a fifth device, a frequency of a reference signal sent by the fourth device is the same as a frequency of a reference signal sent by the fifth device, and the first phase difference is a phase difference between the fourth device and the fifth device, and wherein
the processing, by the first device, a first phase difference for a plurality of second devices based on the first parameter, to obtain a target phase difference comprises: calculating, by the first device, a difference between the first phase difference and a first difference to obtain the target phase difference, wherein the first difference is a difference between a first parameter of the fourth device and a first parameter of the fifth device.

4. The method according to claim 3, further comprising:
measuring, by the first device, a first reference signal sent by the fourth device to obtain a first phase;
measuring, by the first device, a second reference signal sent by the fifth device to obtain a second phase; and
calculating, by the first device, a difference between the first phase and the second phase to obtain the first phase difference.

5. The method according to claim 1, wherein the plurality of second devices comprises a fourth device and a fifth device, wherein the first parameter comprises a hardware delay and an initial phase, and the target phase difference is calculated based on the following expression:
$$Target phase difference = {ϕ}_{r , i}^{s 1} - {ϕ}_{r , i}^{s 2} - ( - {φ}_{i}^{s 1} - {δ}_{i}^{s 1} ) + ( - {φ}_{i}^{s 2} - {δ}_{i}^{s 2} )$$
wherein
$${ϕ}_{r , i}^{s 1}$$
represents a first phase for the fourth device,
$${ϕ}_{r , i}^{s 2}$$
represents a second phase for the fifth device,
$${ϕ}_{r , i}^{s 1} - {ϕ}_{r , i}^{s 2}$$
represents the first phase difference,
$${φ}_{i}^{s 1}$$
represents an initial phase of the fourth device,
$${φ}_{i}^{s 2}$$
represents an initial phase of the fifth device,
$${δ}_{i}^{s 1}$$
represents a hardware delay of the fourth device, and
$${δ}_{i}^{s 2}$$
represents a hardware delay of the fifth device.

6. The method according to claim 1, wherein the first parameter is sent to the first device by one or more of the following: a second device, a base station, or a third device.

7. A positioning method, comprising:
receiving, by a third device, first information, wherein the first information indicates a first parameter of a second device, and the first parameter is related to positioning of a first device; and
receiving, by the third device, second information, wherein the second information comprises a first phase difference for a plurality of second devices; and
processing, by the third device based on the first parameter, the first phase difference for a plurality of second devices, to obtain a target phase difference, wherein the target phase difference is used for positioning the first device.

8. The method according to claim 7, wherein the first parameter comprises one or more of the following: an initial phase, a hardware delay, or a clock error.

9. The method according to claim 8, wherein the plurality of second devices comprise a fourth device and a fifth device, a frequency of a reference signal sent by the fourth device is the same as a frequency of a reference signal sent by the fifth device, and the first phase difference is a phase difference between the fourth and the fifth device; and
processing, by the third device based on the first parameter, the first phase difference for a plurality of second devices, to obtain a target phase difference comprises:
calculating, by the third device, a difference between the first phase difference and a first difference to obtain the target phase difference, wherein the first difference is a difference between a first parameter of the fourth device and a first parameter of the fifth device.

10. The method according to claim 7, wherein the plurality of second devices comprises a fourth device and a fifth device, and wherein the first parameter comprises a hardware delay and an initial phase, and the target phase difference is calculated based on the following expression:
$$Target phase difference = {ϕ}_{r , i}^{s 1} - {ϕ}_{r , i}^{s 2} - ( - {φ}_{i}^{s 1} - {δ}_{i}^{s 1} ) + ( - {φ}_{i}^{s 2} - {δ}_{i}^{s 2} )$$
wherein
$${ϕ}_{r , i}^{s 1}$$
represents a first phase for the fourth device,
$${ϕ}_{r , i}^{s 2}$$
represents a second phase for the fifth device,
$${ϕ}_{r , i}^{s 1} - {ϕ}_{r . i}^{s 2}$$
represents the first phase difference,
$${φ}_{i}^{s 1}$$
represents an initial phase of the fourth device,
$${φ}_{i}^{s 2}$$
represents an initial phase of the fifth device,
$${δ}_{i}^{s 1}$$
represents a hardware delay of the fourth device, and
$${δ}_{i}^{s 2}$$
represents a hardware delay of the fifth device.

11. The method according to claim 7, wherein the first parameter is sent to the third device by one or more of the following: a second device, a first device, a base station, or a positioning reference unit.

12. A positioning method, comprising:
transmitting, by a second device, first information to a third device, wherein the first information indicates a first parameter of the second device, and the first parameter is related to positioning of a first device; and
the first parameter is used by the third device to process a first phase difference for a plurality of second devices to obtain a target phase difference, and the target phase difference is for positioning the first device.

13. The method according to claim 12, wherein the plurality of second devices comprises a fourth device and a fifth device, and wherein the first parameter comprises one or more of the following: an initial phase, a hardware delay, a lock error, a difference between an initial phase of the fourth device and an initial phase of the fifth device, a difference between a hardware delay of the fourth device and a hardware delay of the fifth device, a difference between a clock error of the fourth device and a clock error of the fifth device, a second parameter related to a reference signal sent by the second device, and first indication information, wherein the first indication information indicates whether a second parameter of a first reference signal is equal to a second parameter of a second reference signal; and
the second parameter comprises at least one of a wavelength or a frequency, the first reference signal is sent by the fourth device, and the second reference signal is sent by the fifth device.
